(19) United States
(12) Patent Application Publication
(10) Pub. No.: US 2019/0225238 A1
(43) Pub. Date: Jul. 25, 2019

(54) NOTIFICATION SYSTEM

(71) Applicant: HONDA MOTOR CO., LTD., Tokyo (JP)

(72) Inventors: Shinichi Murakami, Wako-shi (JP); Ken Amemiya, Wako-shi (JP); Masayuki Sato, Wako-shi (JP)

(21) Appl. No.: 16/245,300

(22) Filed: Jan. 11, 2019

(30) Foreign Application Priority Data
Jan. 23, 2018 (JP) 2018-009138

(51) Int. Cl. B60W 50/14; B60W 40/09; B60W 40/107; B60W 40/109

(52) U.S. Cl. CPC B60W 50/14; B60W 40/09; B60W 2540/103; B60W 40/109; B60W 40/107

(57) ABSTRACT

A notification system includes an acquirer configured to acquire acceleration of a vehicle and an operation state of a direction indicator, and a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value and information that makes it possible to recognize that the direction indicator is operated is acquired.

### CROSS-REFERENCE TO RELATED APPLICATION

Priority is claimed on Japanese Patent Application No. 2018-009138, filed Jan. 23, 2018, the content of which is incorporated herein by reference.

### BACKGROUND

### Field of the Invention

The present invention relates to a notification system.

### Description of Related Art

A system that performs a safe driving evaluation on the start and acceleration of a vehicle has been disclosed (see, for example, Patent Document 1). In this system, a message praising a driver is output in a case where the evaluation result is preferable, and a message about advice to a driver is output in a case where the evaluation result is not preferable (Japanese Patent No. 5587465, International Publication No. WO2017/022474).

However, in the related art, it may not be possible to perform advice consistent with the realities of traffic conditions.

The present invention was contrived in view of such circumstances, and one object thereof is to provide a notification system which make it possible to perform a notification consistent with the realities of traffic conditions.

### SUMMARY

A notification system according to this invention adopt the following configurations.

(1) According to an aspect of this invention, there is provided a notification system including: an acquirer configured to acquire acceleration of a vehicle and an operation state of a direction indicator; and a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value and information that makes it possible to recognize that the direction indicator is operated is acquired.

(2) In the aspect of the above (1), the acquirer is configured to acquire information that makes it possible to recognize that the vehicle travels along a descending road, and the controller is not configured to perform the notification in a case where the acceleration is equal to or more than the first predetermined value, and it is determined that the vehicle travels along the descending road on the basis of the information acquired by the acquirer.

(3) In the aspect of the above (1), the acquirer is configured to acquire information indicating a position of an accelerator pedal of the vehicle, and

the controller is not configured to perform the notification in a case where the acceleration is equal to or more than the first predetermined value, and the position of the accelerator pedal is smaller than a second predetermined value.

(4) In the notification system of the aspect of the above (1), the acquirer is configured to acquire information that makes it possible to recognize acceleration of the vehicle in a vertical direction and acceleration of the vehicle in a traveling direction, and the controller is not configured to perform the notification in a case where the acceleration in the traveling direction is equal to or more than the first predetermined value, and the acceleration in the vertical direction is smaller than a third predetermined value.

(5) In the aspect of the above (1, the acquirer is configured to acquire information that makes it possible to recognize acceleration of the vehicle in a vertical direction, information that makes it possible to recognize acceleration of the vehicle in a traveling direction, and information indicating a position of an accelerator pedal of the vehicle, and in a case where the acceleration in the traveling direction is equal to or more than the first predetermined value, the controller is not configured to perform the notification in a case where the position of the accelerator pedal is smaller than a second predetermined value, or the acceleration in the vertical direction is smaller than a third predetermined value.

(6) According to another aspect of this invention, there is provided a notification system including: an acquirer configured to acquire acceleration of a vehicle and information that makes it possible to recognize that the vehicle travels along a descending road; and a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value, and it is determined that the vehicle travels along the descending road on the basis of the information acquired by the acquirer.

(7) According to another aspect of this invention, there is provided a notification system including: an acquirer configured to acquire acceleration of a vehicle in a front-rear axial direction and an operation state of a direction indicator; and a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value and information that makes it possible to recognize that the direction indicator is operated is acquired.

(8) The notification system of (1) is applied to a coaching system of driving for following a preceding vehicle.

According to the above (1), (6) to (8), it is possible to perform a notification consistent with the realities of traffic conditions.

According to the above (2) to (5), it is possible to suppress a notification generated due to acceleration which is not based on a driver's operation.

### BRIEF DESCRIPTION OF THE DRAWINGS

FIG. 1 is a diagram showing an example of a functional configuration of a notification system.

FIG. 2 is a diagram showing an example of content of data transmitted to a terminal device by a data transmitter.

FIG. 3 is a flow chart showing a flow of processes executed centering on a controller.

FIG. 4A is a diagram showing an example of a situation in which a controller notifies an output unit.

FIG. 4B is a diagram showing an example of a situation in which the controller notifies the output unit.

FIG. 4C is a diagram showing an example of a situation in which the controller notifies the output unit.

FIG. 5 is an example of content of information which is output to the output unit.

FIG. 6 is a diagram showing a situation in which a host vehicle controls a direction indicator to be in an on-state during acceleration.

FIG. 7 is a diagram showing a situation in which the host vehicle travels along a descending road.

FIG. 8 is a diagram showing an example of a functional configuration of a terminal device.

FIG. 9 is a diagram showing an example of a hardware configuration of a terminal device of an embodiment.

### DETAILED DESCRIPTION OF EMBODIMENTS

Hereinafter, an embodiment of a notification system of the present invention will be described with reference to the accompanying drawings.

### First Embodiment

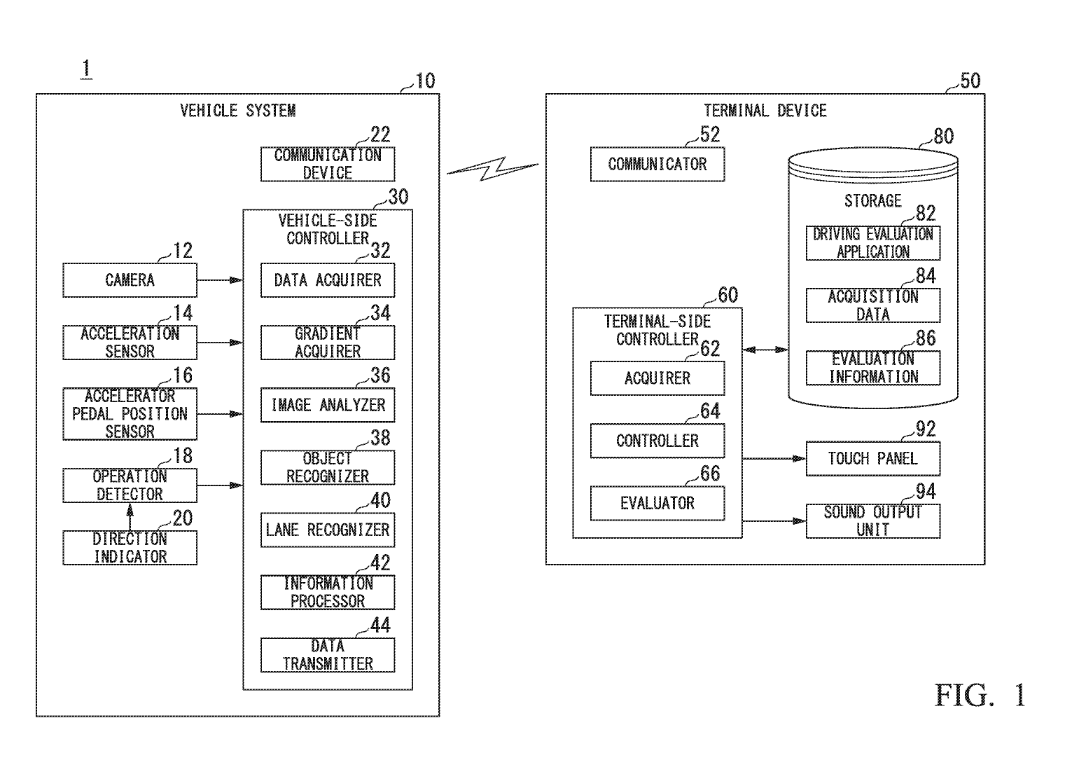

FIG. 1 is a diagram showing an example of a functional configuration of a notification system 1. The notification system 1 includes, for example, a vehicle system 10 and a terminal device 50. The vehicle system 10 and the terminal device 50 communicate with each other using a short-range radio communication standard such as Bluetooth (registered trademark). The vehicle system 10 and the terminal device 50 can communicate with each other by performing, for example, mutual authentication (so-called pairing).

[Vehicle System]

The vehicle system 10 is a system mounted in a vehicle. The vehicle is, for example, a two-wheeled, three-wheeled, or four-wheeled vehicle or the like. The drive source of the vehicle is an internal-combustion engine such as a diesel engine or a gasoline engine, an electric motor, or a combination thereof.

The vehicle system 10 includes, for example, a camera 12, an acceleration sensor 14, an accelerator pedal position sensor 16, an operation detector 18, a direction indicator 20, a communication device 22, and a vehicle-side controller 30. These devices or instruments, the controller, and the like are connected to each other through a multiplex communication line such as a controller area network (CAN) communication line, a serial communication line, a wireless communication network, or the like. The vehicle system 10 may include an electronic control unit (ECU) or the like that controls each unit of a vehicle, in addition to the above functional configuration. The configuration shown in FIG. 1 is merely an example, and portions of the configuration may be omitted, or still other configurations may be added thereto.

The camera 12 is a digital camera using a solid-state imaging element such as, for example, a charge coupled device (CCD) or a complementary metal oxide semiconductor (CMOS). One or a plurality of cameras 12 are installed at any points of a vehicle (hereinafter, called a host vehicle M) having the vehicle system 10 mounted therein. In a case where a forward image is captured, the camera 12 is installed on the upper portion of the front windshield, the rear surface of the rear-view mirror, or the like. The camera 12, for example, repeatedly captures an image of the periphery of the host vehicle M periodically. The camera 12 may be a stereo camera.

A camera that captures a rearward or sideward image may be installed on the host vehicle M in addition to the camera that captures the forward image. Further, a radar device, light detection and ranging (LIDAR), or an object recognition device may be mounted in the host vehicle M in addition to the cameras. The radar device radiates radio waves such as millimeter-waves to the periphery of the host vehicle M, and detects radio waves (reflected waves) reflected from an object to detect at least the position (distance and orientation) of the object. The LIDAR irradiates the periphery of the host vehicle M with light, measures scattered light according to the irradiation light, and detects a distance to an object on the basis of a time from light emission to light reception. The object recognition device recognizes the position, type, speed, or the like of an object by performing a sensor fusion process on detection results based on some or all of the camera 12, the radar device, and the LIDAR.

The acceleration sensor 14 is, for example, an acceleration sensor that detects the acceleration of the host vehicle M. The acceleration sensor 14 is a two-axis or three-axis acceleration sensor, a three-axis gyro sensor, or the like. The vehicle system 10 includes, for example, a vehicle speed sensor that detects a speed, a yaw rate sensor that detects angular velocity around a vertical axis, an orientation sensor that detects the direction of the host vehicle M, or the like in addition to the acceleration sensor 14.

The accelerator pedal position sensor 16 detects the position of an accelerator pedal operated by a crew member, and outputs the detection result to the vehicle-side controller 30.

The operation detector 18 detects an operation for the direction indicator 20. For example, the operation detector 18 detects a state (on-state) in which the direction indicator 20 blinks or a state (off-state) in which it does not blink, and outputs the detection result to the vehicle-side controller 30. The direction indicator 20 starts to blink by a driver's operation of a predetermined operation unit, and stops a blink by performing an operation for a return to a state in which before the predetermined operation unit is operated. The direction indicator 16 stops a blink by a predetermined operation is performed.

The communication device 22 communicates with the terminal device 50 using, for example, Bluetooth or the like. The communication device 22 may communicate with another vehicle which is present in the periphery of the host vehicle M using, for example, a cellular network, a Wi-Fi network, Bluetooth, dedicated short range communication (DSRC), or the like, or may communicate with various server devices through a wireless base station.

The vehicle-side controller 30 includes, for example, a data acquirer 32, a gradient acquirer 34, an image analyzer 36, an object recognizer 38, a lane recognizer 40, an information processor 42, and a data transmitter 44.

The data acquirer 32 is configured to acquire an image captured by the camera 12, a detection result of the acceleration sensor, a detection result of the accelerator pedal position sensor 16, and a detection result of the operation detector 18.

The gradient acquirer 34 is configured to acquire, for example, information that makes it possible to recognize that the host vehicle M travels along a descending road. The gradient acquirer 34 derives and is configured to acquire, for example, the gradient of a road on which the host vehicle M is laid. For example, the gradient acquirer 34 derives the gradient of a road surface on the basis of acceleration in a stationary state. The acceleration in a stationary state is, for example, obtained by subtracting acceleration or the like in a front-rear (traveling or front-rear axis of a vehicle) direction which is obtained by differentiating a vehicle speed detected by the vehicle speed sensor from acceleration which is output by the acceleration sensor 14. The gradient acquirer 34 recognizes whether the host vehicle M travels along a descending road of a predetermined degree or more on the basis of the derived gradient of a road surface. The front-rear axial direction of a vehicle is a front-rear direction in a state in which the steering wheel of a vehicle is controlled to be neutral. The gradient acquirer 34 may derive the acceleration of the host vehicle M in a vertical direction on the basis of the acceleration in a stationary state.

The gradient acquirer 34 may specify position information of the host vehicle M using a global navigation satellite system (GNSS) receiver, and recognize that the host vehicle M travels along a descending road on the basis of the specified position information and map information including information of the gradient of a road. In this case, the vehicle system 10 includes, for example, a GNSS receiver (not shown) and a storage in which map information including information of the gradient of a road is stored.

The image analyzer 36 analyzes the image captured by the camera 12.

The object recognizer 38 detects an object (for example, preceding vehicle that travels in front of the host vehicle M) which is present in the periphery of the host vehicle M and the position of the object on the basis of the analysis result of the image analyzer 36. The position of the object is recognized as, for example, a position in absolute coordinates with a representative point (such as the centroid or the center of a drive shaft) of the host vehicle M as an origin. The position of the object may be represented by a representative point such as the centroid or a corner of the object, or may be represented by a represented region.

The lane recognizer 40 recognizes a traveling lane along which the host vehicle M travels or an adjacent lane which is adjacent to the traveling lane on the basis of the analysis result of the image analyzer 36.

The information processor 42 recognizes the position of the host vehicle M with respect to the traveling lane, the position of an object in the traveling lane, the position of an object with respect to an adjacent lane, and the state of an object on the basis of the recognition result of the object recognizer 38 or the recognition result of the lane recognizer 40. The position of an object is, for example, the position of the object with respect to a lane recognized by the lane recognizer 40. The state of an object is the speed, acceleration, jerk or the like of the object. Further, the information processor 42 derives a distance (distance in a traveling direction or a lateral direction) between an object and the host vehicle M on the basis of the recognition result of the object recognizer 38.

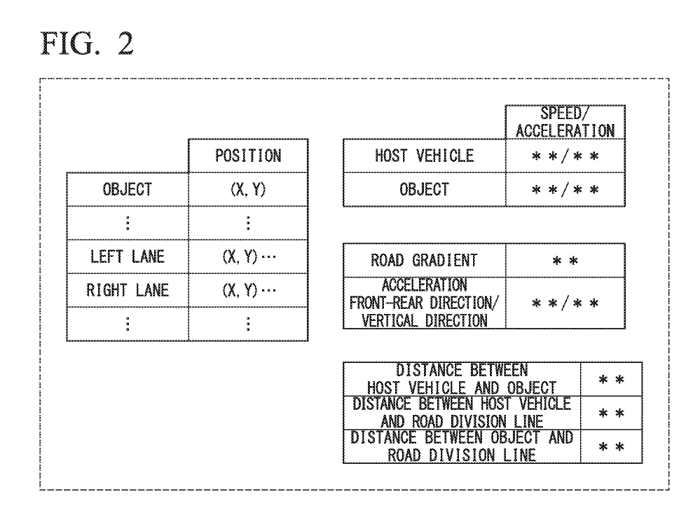

The data transmitter 44 transmits the processing result of the vehicle-side controller 30 to the terminal device 50 using the communication device 22. FIG. 2 is a diagram showing an example of content of data transmitted to the terminal device 50 by the data transmitter 44. Information transmitted from the vehicle system 10 to the terminal device 50 includes, for example, the position of an object, the position of a traveling lane, the position of an adjacent lane, the speed of the host vehicle M or the object, the acceleration of the host vehicle M or the object, the gradient of a road on which the host vehicle M is present, the acceleration of the host vehicle M in a front-rear (traveling) direction, the acceleration of the host vehicle M in a vertical direction, or the like. The information transmitted from the vehicle system 10 to the terminal device 50 is, for example, a distance (distance in a traveling direction or a lateral direction) between the host vehicle M and the object, a distance between the host vehicle M or the object and the road division line of a traveling lane, a distance between the host vehicle M or the object and the road division line of an adjacent lane, or the like.

[Terminal Device]

The terminal device 50 is a terminal device, such as, for example, a smartphone or a tablet terminal, which a crew member can carry. The terminal device 50 includes, for example, a communicator 52, a terminal-side controller 60, a storage 80, a touch panel 92, and a sound output unit 94. The storage 80 is realized by, for example, a read only memory (ROM), a flash memory, an SD card, a random access memory (RAM), a register, or the like. The storage 80 has, for example, a driving evaluation application 82, acquisition data 84, and evaluation information 86 stored therein.

The driving evaluation application 82 is, for example, an application program which is provided by a server under the control of an automobile manufacturer, and is downloaded into the terminal device 50. The driving evaluation application 82 is an application program for evaluating a driver's driving. This application program puts a higher valuation on driving as a degree to which travel of the host vehicle M follows a preceding vehicle becomes higher. The wording “follows to a high degree of” means that a preceding vehicle is followed while maintaining a predetermined inter-vehicle distance. As deviation between this predetermined inter-vehicle distance and an actual inter-vehicle distance becomes larger, the degree of following becomes lower. The predetermined inter-vehicle distance is an inter-vehicle distance between the host vehicle M and a preceding vehicle which is set for each speed of the host vehicle M. Since driving is evaluated by the process of the driving evaluation application 82, a driver can objectively know how well he or she is driving. Since output information such as advice on driving is output by the sound output unit 94 or the like, a driver can receive coaching. Even in a case where users other than a driver offer guidance to a driver, the driving evaluation application 82 can be utilized.

In a case where the acceleration of the host vehicle M is set to be equal to or more than a predetermined value, the driving evaluation application 82 may put a low valuation on driving. Further, in a case where the acceleration of the host vehicle M is set to be equal to or more than the predetermined value, the driving evaluation application 82 causes the output unit (the touch panel 92 or the sound output unit 94) to output information relating to the acceleration of the host vehicle M being set to be equal to or more than the predetermined value with respect to driving.

However, driving in predetermined traffic conditions is not set as a target for evaluation. The predetermined traffic conditions are traffic conditions in which it is appropriate to drive while accelerating the host vehicle M, or are traffic conditions in which acceleration is not generated by a driver's operation. For example, the predetermined traffic conditions are traffic conditions such as merging into a traveling lane from a merging lane in an expressway (or public highway), or are traffic conditions such as traveling along a gradient road. The content of the acquisition data 84 and the evaluation information 86 will be described later.

The communicator 52 communicates with the vehicle system 10 using, for example, Bluetooth or the like. The communication device 22 may communicate with various server devices through a wireless base station using, for example, a cellular network, a Wi-Fi network, Bluetooth, DSRC, or the like.

The terminal-side controller 60 is realized by the driving evaluation application 82 being executed using a processor such as the central processing unit (CPU) of the terminal device 50. The terminal-side controller 60 includes, for example, an acquirer 62, a controller 64, and an evaluator 66.

The acquirer 62 causes the storage 80 to store information transmitted by the vehicle system 10 as the acquisition data 84 (see FIG. 2 described above).

In a case where the acceleration is equal to or more than a predetermined value (first predetermined value), the controller 64 causes an output unit to output a notification for prompting a user to suppress the acceleration of the host vehicle M. The acceleration is, for example, the acceleration of the host vehicle M in a front-rear direction (the acceleration of the host vehicle M in a car-body axial direction).

Even in a case where the acceleration is equal to or more than the predetermined value, the controller 64 does not perform the notification in the cases of the following (1) to (4): (1) is a case where the direction indicator 20 of the host vehicle M is operated, (2) is a case where the host vehicle M travels along a descending road, (3) is a case where the position of the accelerator pedal is smaller than a predetermined value (second predetermined value), and (4) is a case where the acceleration of the host vehicle M in a vertical direction is smaller than a predetermined value (third predetermined value).

The evaluator 66 puts a higher valuation as a degree to which travel of the host vehicle M follows a preceding vehicle becomes higher. The evaluator 66 causes the output unit to output evaluation results (score) after evaluations at predetermined intervals are ended. The evaluator 66 stores the processing results in the storage 80 as the evaluation information 86.

[Flow Chart]

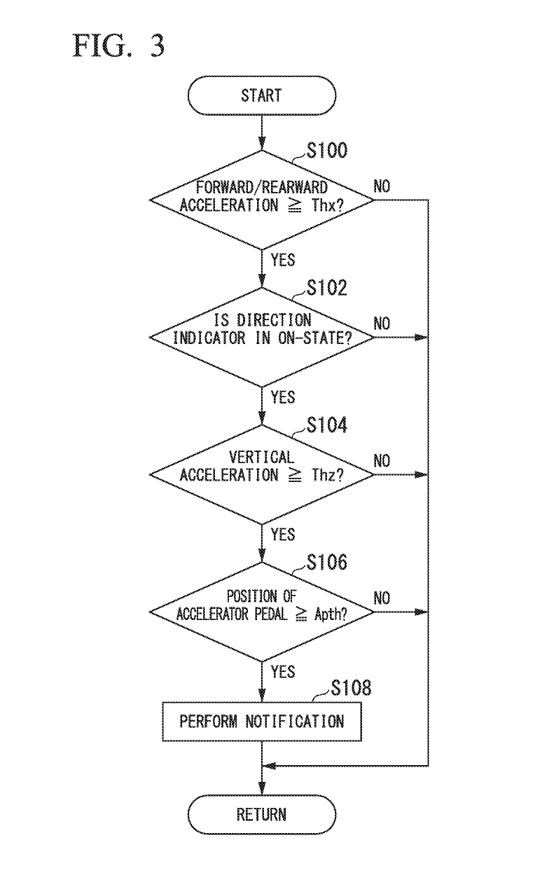

FIG. 3 is a flow chart showing a flow of processes executed centering on the controller 64. In this process, it is assumed that the acquirer 62 acquires information relating to the host vehicle M from the vehicle system 10 at predetermined time intervals.

First, the controller 64 determines whether the acceleration of a car body in a front-rear (front-rear axis) direction is equal to or more than a predetermined value Thx (for example, 0.2 G) (step S100). In a case where the acceleration of the car body in a front-rear direction is equal to or more than the predetermined value Thx, the controller 64 determines whether the direction indicator 20 is in an off-state (step S102).

In a case where the direction indicator 20 is in an off-state, the controller 64 determines whether the acceleration of the car body in a vertical direction is equal to or more than a predetermined value Thz (which may be a value exceeding, for example, 1.0 G, or 1.0 G) (step S104). The predetermined value Thz is an example of the “third predetermined value”.

In a case where the acceleration of the car body in a vertical direction is equal to or more than the predetermined value Thz, the controller 64 determines whether the position of the accelerator pedal is equal to or more than a predetermined value APth (step S106). The predetermined value APth is an example of the “second predetermined value”.

In a case where the position of the accelerator is equal to or more than a predetermined value APth, the controller 64 causes the output unit to perform the notification (step S108). In a case where some of the processes of step S100 to step S106 are negative, the controller 64 does not cause the output unit to perform the notification. Thereby, processes of one routine of this flow chart are ended.

Some of the processes in the flow chart of FIG. 3 described above may be omitted. For example, the process of step S102 may be omitted. For example, one or both of the processes of step S104 or step S106 may be omitted.

The order of the processes in the flow chart of FIG. 3 described above may be changed. For example, the order of the processes of step S104 and step S106 may be switched. The process of step S102 may be executed after the process of step S104 or step S106.

In the above-described processes, it is possible to perform a notification consistent with the realities of traffic conditions, and to suppress a notification generated due to acceleration which is not based on a driver's operation.

[Situation 1]

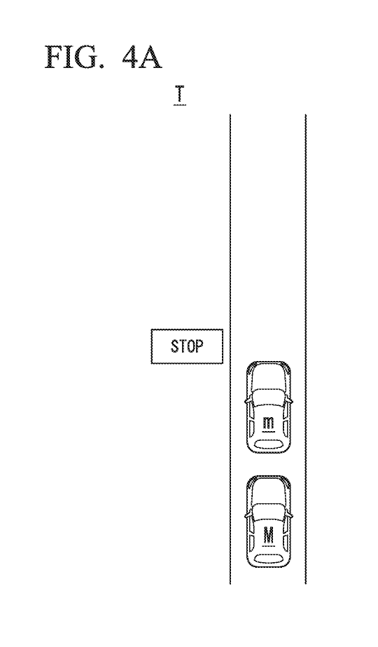

FIGS. 4A, 4B, and 4C are diagrams showing an example of a situation in which the controller 64 notifies the output unit. In a situation 1, it is assumed that a user who owns the terminal device 50 drives the host vehicle M having the vehicle system 10 mounted therein. In the situation 1, the driving evaluation application 82 is executed, a driver is in a state of receiving an evaluation performed by the driving evaluation application 82, and the driver is in a state of receiving coaching.

In FIG. 4A, the host vehicle M and a preceding vehicle m have stopped at a signal. As shown in FIG. 4B, a signal indicates traveling, the preceding vehicle m starts, and the host vehicle M attempts to start subsequently to this preceding vehicle m.

In this case, as shown in FIG. 4C, a driver of the host vehicle M steps on the accelerator and accelerates the host vehicle M in order to follow the preceding vehicle m. In this case, the host vehicle M increases in the inter-vehicle distance between the host vehicle M and the preceding vehicle m due to a delay of start timing, traveling of the preceding vehicle m, the degree of following in the host vehicle M, or the like.

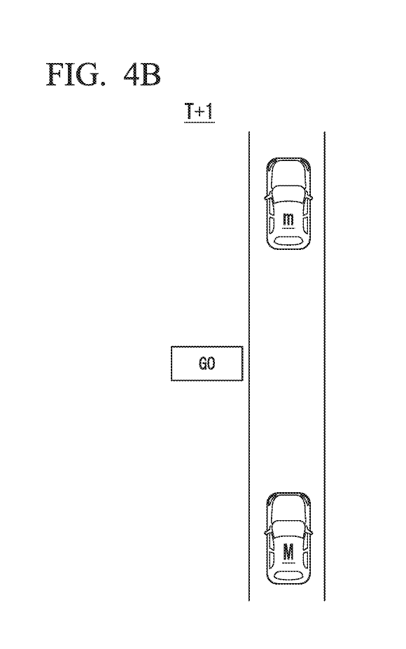

However, it is not appropriate to cause the host vehicle M to execute acceleration more than a predetermined degree in terms of the deterioration of fuel efficiency or power efficiency or the like. For this reason, the controller 64 outputs output information (for example, “Acceleration more than a predetermined degree”) indicating acceleration more than a predetermined degree as shown in FIG. 5. Thereby, a driver can recognize acceleration more than a predetermined degree, and perform an operation appropriate to that occasion. It is possible to perform coaching of more preferable driving in output content which is output by the output unit of the terminal device 50.

In a case where acceleration more than a predetermined degree is performed, the evaluator 66 may put a low valuation on driving. In this case, the driving evaluation application 82 simply determines whether acceleration more than a predetermined degree is performed on the basis of information on the position of the accelerator, and performs an evaluation according to predetermined conditions as described below rather than performs an evaluation on driving on the basis of the determination result. Therefore, the driving evaluation application 82 does not put a low valuation on predetermined acceleration without evaluating acceleration uniformly. Thereby, a driver's degree of conviction of an evaluation is improved.

The above-described output information may be information for prompting a user to suppress the acceleration of a vehicle. The information for prompting a user to suppress acceleration may be variously represented as in, for example, “Suppress”, “More than a Predetermined degree”, or the like. For example, in a case where “More than a predetermined degree” is output, a user can recognize his or her degree of operation on the basis of this output information, and recognize the prompt of suppression. The information for prompting a user to suppress acceleration also includes information for recommending suppressing an operation within a threshold. An example of the output of the information for recommending suppressing this operation within a threshold also includes output of information indicating that the operation of a vehicle exceeds a threshold, and a driver can recognize the prompt of suppression even in the case of any output. The notification may be any or a combination of sound, signal sound, vibration of a member, lighting of a lamp, screen display, or the like, may be characters, numerals, signs, pictures, photographs, or moving images, or may be a change of a tone, a tone color or the like in the case of sound, or a change of a shape, a color, brightness, a motion or the like in the case of display.

As described above, a driver can objectively know how well he or she is driving through the process of the driving evaluation application 82, and receive coaching through output information of the system. Even in a case where users other than a driver offer guidance to a driver, the driving evaluation application can be utilized.

As described in FIG. 5 stated above, in a case where acceleration more than a predetermined degree is performed, a notification is performed, but it may be appropriate for acceleration more than a predetermined degree to be performed depending on the traffic conditions. In such a case (for example, in the following situation 2 and situation 3), the controller 64 does not perform a notification.

[Situation 2]

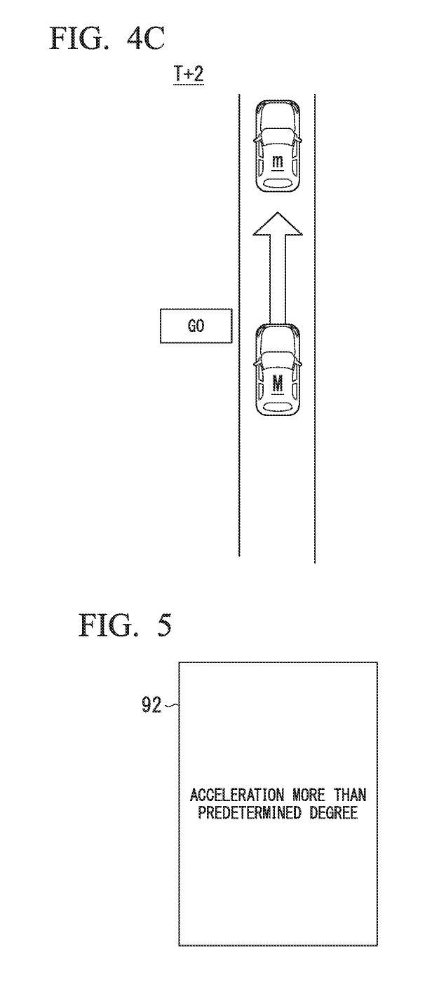

FIG. 6 is a diagram showing a situation in which the host vehicle M controls the direction indicator 20 to be in an on-state during acceleration. As shown in FIG. 6, it is assumed that the host vehicle M and the preceding vehicle m travel along a merging lane, and another vehicle ml travels along a traveling lane L2 adjacent to the merging lane L1. The preceding vehicle m, the host vehicle M, and another vehicle ml travel in this order in a front-rear direction. A case is considered in which a driver has determined that it is appropriate to merge into the traveling lane L2 so as to travel in front of another vehicle ml in the traveling lane L2. In this case, the driver sets the direction indicator 20 to be in an on-state, accelerate to more than predetermined degree, and merges from the merging lane L1 into the traveling lane L2.

As described above, in a case where the direction indicator 20 is controlled to be in an on-state for the purpose of merging, and the host vehicle M accelerates, the controller 64 does not perform a notification. Such a process is performed, whereby a notification which is not appropriate is suppressed in actual traffic conditions.

[Situation 3]

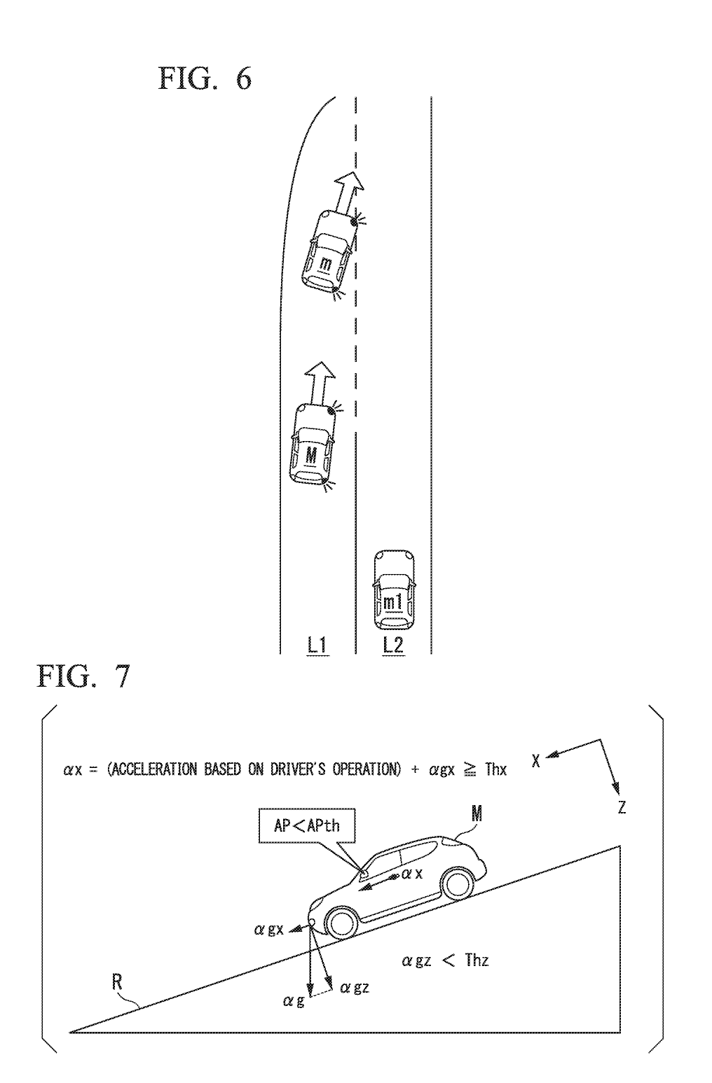

FIG. 7 is a diagram showing a situation in which the host vehicle M travels along a descending road R. In the following description, the front-rear direction (front-rear axial direction) of a vehicle is defined as an X direction, and the vertical direction of the vehicle is defined as a Z direction. In a case where the vehicle travels along the descending road R, acceleration αg based on its own weight is generated in the host vehicle M. The acceleration αg is resolved into acceleration αgx in the X direction and acceleration αgz in the Z direction. The acceleration αgz is, for example, information derived by the vehicle-side controller 30 on the basis of the detection result of the acceleration sensor 14 or the like. A case where an acceleration ax in the X direction is equal to or more than the predetermined value Thx is considered. In a case where the acceleration ax is equal to or more than the predetermined value Thx, the acceleration ax may be generated by not only a driver's operation, but also the gradient of the descending road R, that is, the influence of the acceleration αg. The acceleration ax is obtained by, for example, the following Expression (1). Here, “αh” is acceleration based on a driver's operation.

αx=αh+αgx

In a case where the acceleration αgz in the Z direction is less than the predetermined value Thz and the accelerator position AP is less than the predetermined value APth even when the acceleration ax in the X direction is equal to or more than the predetermined value Thx, the controller 54 determines that the acceleration ax is equal to or more than the predetermined value Thx due to the gradient of the descending road R rather than a driver's operation, and does not perform a notification.

As described above, in a case where the acceleration ax of the car body in a front-rear direction is equal to or more than the predetermined value Thx due to the influence of the descending road R, the controller 64 does not perform a notification. Such a process is performed, whereby a notification consistent with the traffic conditions is performed.

A method of determining whether acceleration equal to or more than the predetermined value Thx is generated due to the gradient of the descending road R rather than a driver's operation is not limited to the above-described embodiment. For example, it may be determined whether acceleration equal to or more than the predetermined value Thx is generated due to the gradient of the descending road R on the basis of map information in which a relationship between output of an engine (or motor) which is a motive power source for traveling a vehicle and acceleration are associated with each other. For example, in a case where acceleration equal to or more than the predetermined value Thx is generated in spite of the output of an engine being zero, it is determined that acceleration is generated due to a gradient.

In the above-described embodiment, a description has been given in which the terminal-side controller 60 is implemented by the driving evaluation application 82 being executed, but there is no limitation thereto. For example, some of the functional units of the terminal-side controller 60 may be implemented by a hardware processor such as, for example, a central processing unit (CPU) executing a program (software). Some or all of these components may be implemented by hardware (circuit unit; including circuitry) such as a large scale integration (LSI), an application specific integrated circuit (ASIC), a field-programmable gate array (FPGA), or a graphics processing unit (GPU), and may be implemented by cooperation between software and hardware.

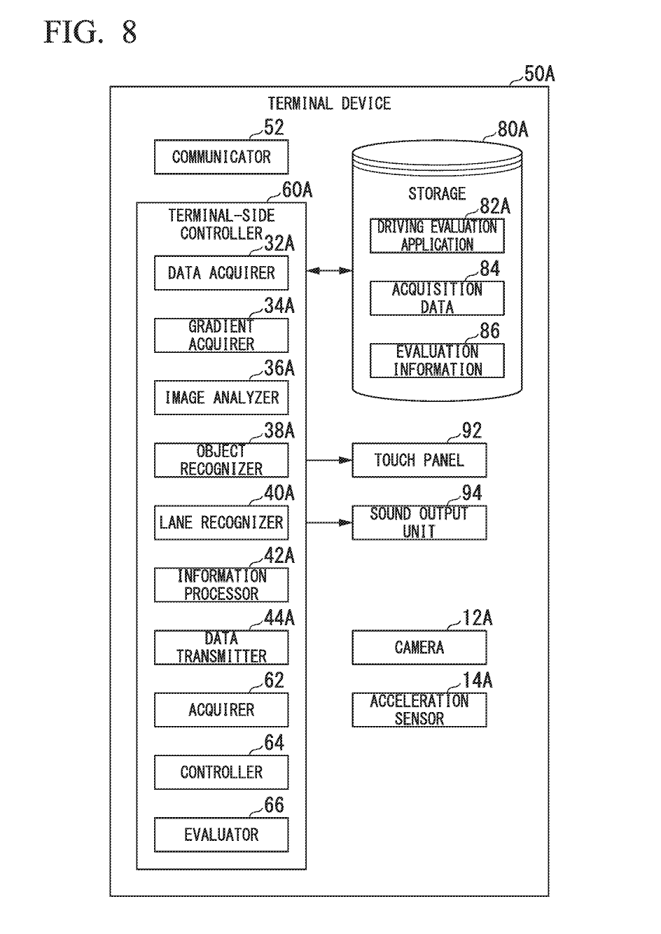

Some or all of instruments or functional units included in the terminal device 50 may be included in the vehicle system 10. On the contrary, some or all of instruments or functional units included in the vehicle system 10 may be included in the terminal device 50 as shown in FIG. 8.

FIG. 8 is a diagram showing an example of a functional configuration of a terminal device 50A. The terminal device 50A includes, for example, a camera 12A and an acceleration sensor 14A in addition to the functional configuration of the terminal device 50. The camera 12A has the same function as that of the camera 12. The acceleration sensor 14A derives acceleration.

The terminal device 50A includes a terminal-side controller 60A instead of the terminal-side controller 60. The terminal-side controller 60A includes a data acquirer 32A, a gradient acquirer 34A, an image analyzer 36A, an object recognizer 38A, a lane recognizer 40A, an information processor 42A, and a data transmitter 44A in addition to the functional configuration of the terminal-side controller 60. The data acquirer 32A, the gradient acquirer 34A, the image analyzer 36A, the object recognizer 38A, the lane recognizer 40A, the information processor 42A, and the data transmitter 44A have the same functions as those of the data acquirer 32, the gradient acquirer 34, the image analyzer 36, the object recognizer 38, the lane recognizer 40, the information processor 42, and the data transmitter 44, respectively.

The terminal device 50A includes a storage 80A instead of the storage 80. A driving evaluation application 82A is stored in the storage 80A instead of the driving evaluation application 82. The terminal-side controller 60A is implemented by the driving evaluation application 82A being executed using a processor such as the CPU of the terminal device 50. The data acquirer 32A, the gradient acquirer 34A, the image analyzer 36A, the object recognizer 38A, the lane recognizer 40A, and the information processor 42A are implemented by the driving evaluation application 82A being executed by a processor.

The terminal device 50A is fixed to, for example, a stand or the like provided on the upper surface of the instrument panel of the host vehicle M. Specifically, in a state where the driving evaluation application 82A is executed, the terminal device 50A is installed at a position at which the acceleration sensor 14A can appropriately detect the acceleration of the host vehicle M, and at a position at which a forward image of the vehicle can be captured by the camera 12A. The terminal device 50A executes a process relating to a notification or an evaluation process on the basis of the acceleration detected by the acceleration sensor 14A and the image captured by the camera 12A.

According to the embodiment described above, it is possible to perform a notification consistent with the realities of traffic conditions by including the acquirer 62 that acquires the acceleration of the host vehicle M and the operation state of the direction indicator 20, and the controller 64 that causes the output unit to output a notification for prompting a user to suppress the acceleration of the host vehicle M in a case where the acceleration is equal to or more than the first predetermined value, the controller 64 not performing the notification in a case where the acceleration is equal to or more than the first predetermined value and information that makes it possible to recognize that the direction indicator 20 is operated is acquired.

[Hardware Configuration]

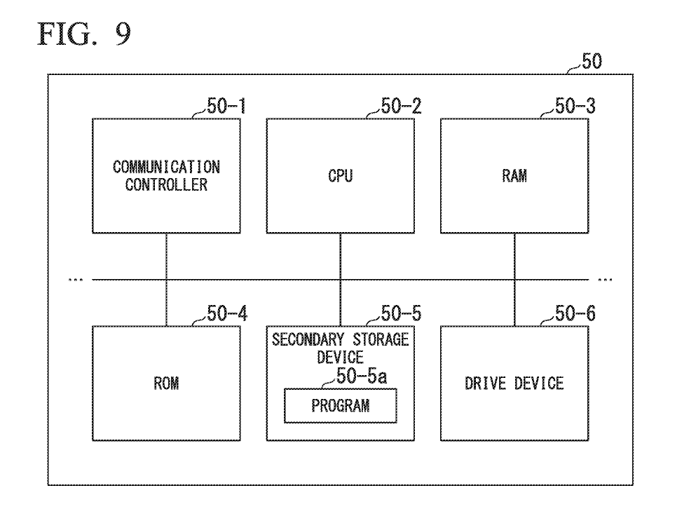

The terminal device 50 of the above-described embodiment is implemented by, for example, the hardware configuration as shown in FIG. 9. FIG. 9 is a diagram showing an example of a hardware configuration of the terminal device 50 of an embodiment.

The terminal device 50 is configured such that a communication controller 50-1, a CPU 50-2, a RAM 50-3, a ROM 50-4, a secondary storage device 50-5 such as a flash memory or an HDD, and a drive device 50-6 are connected to each other through an internal bus or a dedicated communication line. The drive device 50-6 has a portable storage medium such as an optical disc mounted thereon. A program 50-5a stored in the secondary storage device 50-5 is developed into the RAM 50-3 by a DMA controller (not shown) or the like and is executed by the CPU 50-2, whereby the terminal-side controller 60 is implemented. The program (for example, the driving evaluation application 82) which is referred to by the CPU 50-2 may be stored in a portable storage medium mounted in the drive device 50-6, and may be downloaded from other devices through a network NW.

The above embodiment can be represented as follows.

A notification system including:

a storage device; and

a hardware processor configured to execute a program stored in the storage device,

wherein the hardware processor executes the program to:

acquire acceleration of a vehicle and an operation state of a direction indicator,

cause an output unit to output a notification for prompting a user to suppress the acceleration of the vehicle in a case where the acceleration is equal to or more than a first predetermined value, and

not cause the output unit to output the notification in a case where the acceleration is equal to or more than the first predetermined value and information that makes it possible to recognize that the direction indicator is operated is acquired.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A notification system comprising:
an acquirer configured to acquire acceleration of a vehicle and an operation state of a direction indicator; and
a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value and information that makes it possible to recognize that the direction indicator is operated is acquired.

2. The notification system according to claim 1,
wherein the acquirer is configured to acquire information that makes it possible to recognize that the vehicle travels along a descending road, and
the controller is not configured to perform the notification in a case where the acceleration is equal to or more than the first predetermined value, and it is determined that the vehicle travels along the descending road on the basis of the information acquired by the acquirer.

3. The notification system according to claim 1,
wherein the acquirer is configured to acquire information indicating a position of an accelerator pedal of the vehicle, and
the controller is not configured to perform the notification in a case where the acceleration is equal to or more than the first predetermined value, and the position of the accelerator pedal is smaller than a second predetermined value.

4. The notification system according to claim 1,
wherein the acquirer is configured to acquire information that makes it possible to recognize acceleration of the vehicle in a vertical direction and acceleration of the vehicle in a traveling direction, and
the controller is not configured to perform the notification in a case where the acceleration in the traveling direction is equal to or more than the first predetermined value, and the acceleration in the vertical direction is smaller than a third predetermined value.

5. The notification system according to claim 1,
wherein the acquirer is configured to acquire information that makes it possible to recognize acceleration of the vehicle in a vertical direction, information that makes it possible to recognize acceleration of the vehicle in a traveling direction, and information indicating a position of an accelerator pedal of the vehicle, and
in a case where the acceleration in the traveling direction is equal to or more than the first predetermined value, the controller is not configured to perform the notification in a case where the position of the accelerator pedal is smaller than a second predetermined value, or the acceleration in the vertical direction is smaller than a third predetermined value.

6. A notification system comprising:
an acquirer configured to acquire acceleration of a vehicle and information that makes it possible to recognize that the vehicle travels along a descending road; and
a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value, and it is determined that the vehicle travels along the descending road on the basis of the information acquired by the acquirer.

7. A notification system comprising:
an acquirer configured to acquire acceleration of a vehicle in a front-rear axial direction and an operation state of a direction indicator; and
a controller configured to cause an output unit to output a notification for prompting a user to suppress the acceleration of the vehicle in a case where the acceleration is equal to or more than a first predetermined value, the controller not performing the notification in a case where the acceleration is equal to or more than the first predetermined value and information that makes it possible to recognize that the direction indicator is operated is acquired.

8. The notification system according to claim 1,
wherein the notification system is applied to a coaching system of driving for following a preceding vehicle.
